(19) United States
(12) Patent Application Publication
(10) Pub. No.: US 2024/0034137 A1
(43) Pub. Date: Feb. 1, 2024

(54) AN ELECTRIFIED POWERTRAIN SYSTEM FOR A VEHICLE

(71) Applicant: Hercules Electric Mobility, Inc., Farmington Hills, MI (US)

(72) Inventors: Gregory Thomas Weber, Commerce Twp., MI (US); James Edward Breyer, Livonia, MI (US)

(73) Assignee: Hercules Electric Mobility, Inc., Farmington Hills, MI (US)

(21) Appl. No.: 18/256,291

(22) PCT Filed: Dec. 7, 2021
(86) PCT No.: PCT/US2021/062167

§ 371 Date: Jun. 7, 2023

Related U.S. Application Data
(60) Provisional application No. 63/122,178, filed on Dec. 7, 2020.

(51) Int. Cl. B60K 1/02; B62D 21/02; B60G 9/02; B60K 17/08; B60L 15/00; F16H 57/02; B60K 1/00; B60G 15/06; B60B 35/12; B60B 35/14; B62D 65/02

(52) U.S. Cl. CPC B60K 1/02; B62D 21/02; B60G 9/02; B60K 17/08; B60L 15/007; F16H 57/02; B60K 1/00; B60G 15/06; B60B 35/128; B60B 35/14; B62D 65/02; F16H 2057/02034; F16H 2057/02052; B60K 2001/001; B60G 2300/50; B60G 2200/326; B60G 2800/162

(57) ABSTRACT

An electrified powertrain system for a vehicle is provided that integrates the electric machine(s) as part of the sprung mass of the vehicle, i.e., vehicle components that are supported on the suspension system, such as a unibody arrangement or a body-on-frame arrangement.

### CROSS-REFERENCE TO RELATED APPLICATIONS

This application claims the benefit of U.S. Provisional Patent Application No. 63/122,178, filed on Dec. 7, 2020, the disclosure of which is hereby incorporated by reference.

### INTRODUCTION

One approach for implementing an electrified powertrain system on a larger vehicle includes attaching an electric machine directly to a wheel assembly or a solid axle. Such an approach increases unsprung mass of the vehicle, i.e., increases the mass of elements of the vehicle that follows road contours, such as wheels, tires, brake assemblies, steering elements, knuckles, etc. This approach adds a large amount of mass to the axle, which negatively affects vehicle ride and handling and vehicle stability. Such an approach adds durability requirements to electric machine components, and may affect service life of the electric machine.

### SUMMARY

An electrified powertrain system for a vehicle is provided that integrates the electric machine(s) as part of the sprung mass of the vehicle, i.e., vehicle components that are supported on the suspension system, such as a unibody arrangement or a body-on-frame arrangement.

The electrified powertrain system includes an electric machine, a gearbox, and first and second half-shafts; and a solid axle. The solid axle includes a first hub mount disposed on a first end thereof, a second hub mount disposed on a second end thereof, and first and second wheel mounts. The first and second wheel mounts are disposed on the first and second hub mounts, respectively. A frame member of the vehicle is supported on the solid axle via springs. The electric machine and the gearbox are rigidly supported on the frame member of the vehicle. The electric machine is rotatably coupled to the first and second wheel mounts via the gearbox and the first and second half-shafts.

An aspect of the disclosure includes first and second constant velocity joints coupled to the first and second wheel mounts, respectively; wherein the electric machine is rotatably coupled to the first and second wheel mounts via the gearbox, the first and second half-shafts, and the first and second constant velocity joints.

Another aspect of the disclosure includes the frame member being one of a frame cross-member, a subframe, or a cradle.

Another aspect of the disclosure includes the frame member being a unibody configuration.

Another aspect of the disclosure includes an electric power inverter electrically coupled to the electrical machine and rigidly supported on the frame member of the vehicle.

Another aspect of the disclosure includes the gearbox being a single input, dual output gearbox.

Another aspect of the disclosure includes the frame member of the vehicle being supported on the solid axle via shock absorption devices and the springs.

Another aspect of the disclosure includes the solid axle having first and second laterally-oriented box channel elements and a stiffening tab that are arranged between first and second hub mounts, wherein the stiffening tab is mechanically coupled to the first and second laterally-oriented box channel elements, and wherein the first and second hub mounts are attached to the first and second hub mounts via hub bolts.

Another aspect of the disclosure includes an electrified powertrain system for a vehicle that has first and second electric machines, a gearbox, first and second half-shafts, and first and second constant velocity joints; and a solid axle. The solid axle has a first hub mount disposed on a first end thereof, a second hub mount disposed on a second end thereof, and first and second wheel mounts. The first and second wheel mounts are disposed in the first and second hub mounts, respectively, a frame member of the vehicle is supported on the solid axle via springs, the first and second electric machines and the gearbox are rigidly supported on the frame member of the vehicle; and the electric machine is rotatably coupled to the first and second wheel mounts via the gearbox, the first and second half-shafts, and the first and second constant velocity joints.

Another aspect of the disclosure includes a method for configuring a vehicle having an electrified powertrain by configuring the electrified powertrain to have at least one electric machine, a gearbox, and first and second half-shafts, and configuring a solid axle. The solid axle has a first hub mount disposed on a first end thereof, a second hub mount disposed on a second end thereof, first and second wheel mounts. The method includes arranging the at least one electric machine and the gearbox as a sprung mass, wherein the sprung mass is disposed on a frame member of the vehicle, and arranging the solid axle as an unsprung mass. The method further includes rotatably coupling the first and second wheel mounts to the first and second half-shafts via constant velocity joints.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 schematically illustrates a side view of a four-wheel vehicle employing an electrified powertrain system, in accordance with the disclosure.

FIG. 2 schematically illustrates a side view of a frame portion of a four-wheel vehicle an electrified powertrain system, in accordance with the disclosure.

FIG. 3 schematically illustrates a rear view of one embodiment of an electrified powertrain system, in accordance with the disclosure.

FIG. 4 schematically illustrates a top view of an in-line solid axle that is an element of the electrified powertrain system that is described with reference to FIG. 3, in accordance with the disclosure.

FIG. 5 schematically illustrates a cross-sectional side view of a solid axle that is an element of the electrified powertrain system that is described with reference to FIG. 3, in accordance with the disclosure.

FIG. 6 schematically illustrates a top view of a forward-offset solid axle that is an element of the electrified powertrain system that is described with reference to FIG. 3, in accordance with the disclosure.

FIG. 7 schematically illustrates a top view of a rearward-offset solid axle that is an element of the electrified powertrain system that is described with reference to FIG. 3, in accordance with the disclosure.

FIG. 8 schematically illustrates a rear view of a bottom-offset solid axle that is an element of the electrified powertrain system that is described with reference to FIG. 2, in accordance with the disclosure.

FIG. 9 schematically illustrates a rear view of a top-offset solid axle that is an element of the electrified powertrain system that is described with reference to FIG. 2, in accordance with the disclosure.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure.

The following detailed description is merely exemplary in nature and is not intended to limit the application and uses. Furthermore, there is no intention to be bound by any expressed or implied theory presented in the preceding background or brief summary, or in the following detailed description. Throughout the drawings, corresponding reference numerals indicate like or corresponding parts and features.

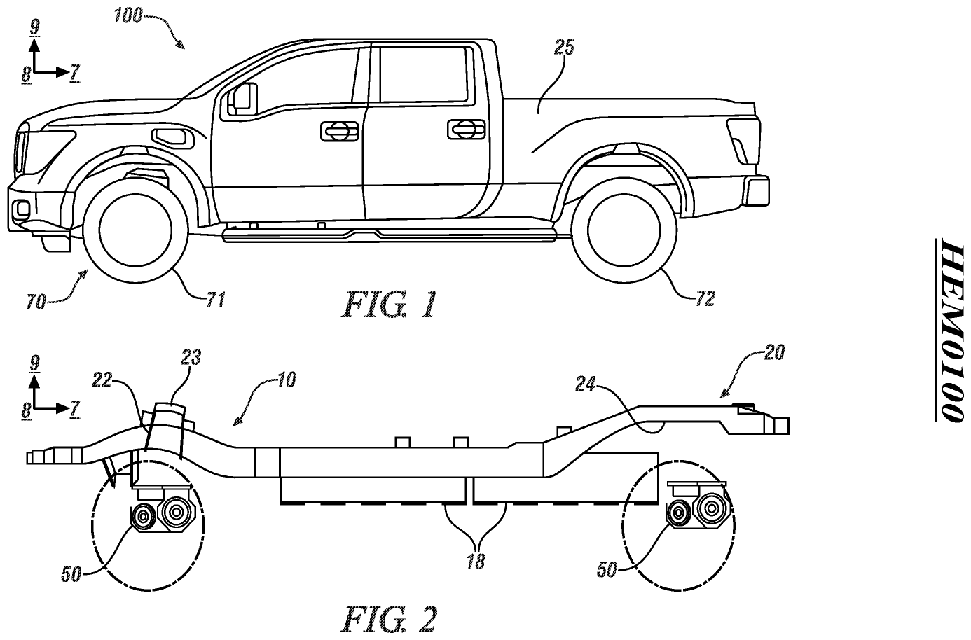

FIGS. 1, 2, and 3 schematically illustrate elements of an embodiment of a vehicle 100 that includes an electrified powertrain system wherein the electric machine(s) are integrated as part of the sprung mass of the vehicle 100. The vehicle 100 may include, but not be limited to a mobile platform in the form of a commercial vehicle, an industrial vehicle, an agricultural vehicle, a passenger vehicle, a train, an all-terrain vehicle, a personal movement apparatus, a robot and the like to accomplish the purposes of this disclosure. The vehicle 100 includes a vehicle body 25 arranged on a frame 20 that supports an electrified powertrain system 10 coupled to a geartrain 30. The vehicle 100 also includes a solid axle 40, wheel mounts 50, a suspension system 60, and vehicle wheels 70. The electrified powertrain system 10 and the geartrain 30 are arranged on the frame 20 as sprung mass. The electrified powertrain system 10 is coupled to the geartrain 30 to transfer tractive power to the wheels 70 for vehicle propulsion. The vehicle 100 is arranged with many elements of the electrified powertrain system 10 being integrated into the frame 20 as part of the sprung mass of the vehicle 100, i.e., vehicle components that are supported on the suspension system 60. Elements of the vehicle 100 may be described with reference to a lateral or x-axis 7, a longitudinal or y-axis 8, and an elevation or z-axis 9.

The electrified powertrain system 10 includes, in one embodiment, first and second electric machines 12, 14, respectively, an inverter module 16, and a DC power source (HV battery) 18, with operations being controlled by a controller 15.

The first and second electric machines 12, 14 may be high-voltage multi-phase electric motor/generators that are configured to convert stored electric energy to mechanical power and convert mechanical power to electric energy that may be stored in the HV battery 18. The HV battery 18 may be a high-voltage energy storage device, e.g., a multi-cell lithium ion device, an ultra-capacitor, or another device without limitation. Monitored parameters related to the HV battery 18 may include a state of charge (SOC), temperature, and others. In one embodiment, the HV battery 18 may electrically connect via an on-vehicle battery charger (not shown) to a remote, off-vehicle electric power source for charging while the vehicle 100 is stationary. The HV battery 18 electrically connects to the inverter module 16 via a HV DC electric power bus to transfer high-voltage DC electric power via three-phase conductors to the first and second electric machines 12, 14 in response to control signals originating in a control system.

The first and second electric machines 12, 14 each includes a rotor and a stator, and each electrically connects via the inverter module 16 and the HV DC electric power bus to the HV battery 18. The inverter module 16 is configured with control circuits including power transistors, e.g., IGBTs, for transforming high-voltage DC electric power to high-voltage AC electric power and transforming high-voltage AC electric power to high-voltage DC electric power. The inverter module 16 employs pulsewidth-modulating (PWM) control of the IGBTs to convert stored DC electric power originating in the HV battery 18 to AC electric power to drive the first and second electric machines 12, 14 to generate torque. Similarly, the inverter module 16 converts mechanical power transferred to the first and second electric machines 12, 14 to DC electric power to generate electric energy that is storable in the HV battery 18, including as part of a regenerative control strategy. The inverter module 16 receives motor control commands and controls inverter states to provide the motor drive and regenerative braking functionality.

The controller 15 includes a plurality of discrete devices that may be co-located with the individual elements of the electrified powertrain system 10 to effect operational control of the individual elements, including, e.g., the inverter module 16. The controller 15 may also include a control device that provides hierarchical control of other control devices. The controller 15 communicates with the inverter module 16 and the on-vehicle battery charger, either directly or via a communication bus to monitor and control operation.

The geartrain 30 includes a gearbox 32 that rotatably couples to first and second half-shafts 34, 36, respectively. As shown and in one embodiment, the geartrain 30 is configured to transfer torque between the first and second electric machines 12, 14, and the vehicle wheels 70. As shown, the geartrain 30 is configured as a dual motor-dual output gearbox that couples to the first and second half-shafts 34, 36 to transfer torque to respective first and second drive wheels 71, 72 via a respective constant velocity (CV) joint 52.

Alternatively, the electrified powertrain system 10 may be configured to include a single electric machine coupled to a single motor-single output gearbox to transfer torque to one of the first and second drive wheels 71, 72.

Alternatively, the electrified powertrain system 10 may be configured to include a single electric machine coupled to a single motor-dual output gearbox to transfer torque to the first and second drive wheels 71, 72.

Alternatively, the electrified powertrain system 10 may be configured to include two electric machines coupled to a dual motor-single output gearbox to transfer torque to one of the first and second drive wheels 71, 72.

The frame 20 may be configured in a unibody arrangement or a body-on-frame arrangement. The frame 20 includes a frame member 22 that is arranged transverse to the longitudinal axis 8 of the vehicle 100 and thus parallel to the lateral axis 7. The frame member 22 provides a mounting structure for the electrified powertrain system 10, including the first and second electric machines 12, 14, the inverter module 16, the HV battery 18, and the gearbox 32 of the geartrain 30. The frame member 22 may be a frame cross-member, a subframe, a cradle, or another frame member. The frame 20 also includes frame shock mounts 23 and frame spring mounts 24 for coupling the frame 20 to the solid axle 40 via the suspension system 60.

The solid axle 40 is arranged on an underside of the vehicle 100 in a lateral orientation, and is coupled to the frame 20 via the suspension system 60.

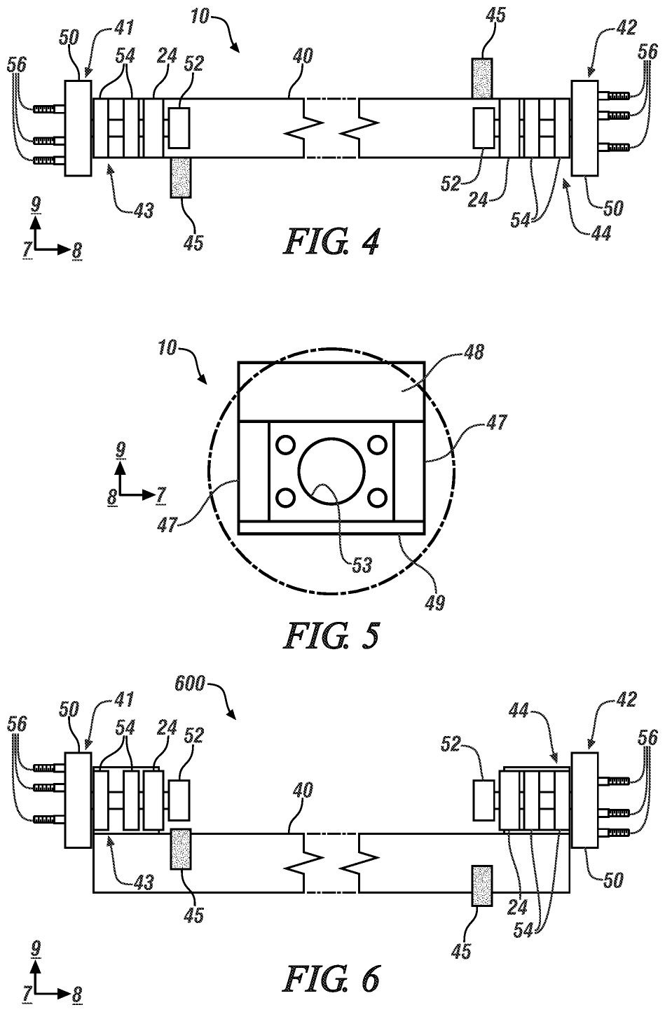

Referring to FIGS. 4 and 5, the solid axle 40 includes, in one embodiment, first and second elongated box channels 47, 48, respectively, which are fabricated from one of steel, aluminum, composite material, etc. The first and second elongated box channels 47, 48 are arranged with elongated axes that are parallel with the lateral axis 7, with one or multiple stiffening tabs 49 fastened therebetween. The solid axle 40 includes a first end 41 and a second end 42. A first hub mount 43 including a plurality of hub bolts is disposed on the first end 41, and a second hub mount 44 including a plurality of hub bolts is disposed on the second end 42. The solid axle 40 also includes axle shock mounts 45 and axle spring mounts 46 for coupling the frame 20 to the solid axle 40 via the suspension system 60.

The wheel mounts 50 are attached to the first and second hub mounts 43, 44 of the solid axle 40 via the hub bolts and associated fasteners. Each of the wheel mounts 50 includes a wheel spindle 51, CV joint 52, bearing hub 53, wheel bearing 54, wheel brake 55 including brake rotor 55a, and one or multiple wheel studs 56. Individual wheels 70 are attached to the wheel mounts 50 via the wheel studs 56 and associated fasteners, e.g., lugnuts.

In this embodiment, the wheel spindles are coaxial with the solid axle 40.

The suspension system 60 includes leaf springs 62 and shock absorbers 64. The leaf springs 62 are fastened to and disposed between the frame spring mounts 24 and the axle spring mounts 46. The shock absorbers 64 are fastened to and disposed between the frame shock mounts 23 and the axle shock mounts 45.

The wheels 70 include first and second drive wheels 71, 72, respectively.

As described herein, the first and second electric machines 12, 14 are mechanically decoupled from the solid axle 40 utilizing half shafts to provide the mechanical connection between the gear box and the wheels. This reduces the unsprung mass of the axle, which will improve ride and handling.

The solid axle 40 includes, in one embodiment, first and second elongated box channels 47, 48, respectively, which are fabricated from steel, aluminum, composite material etc.

Referring to FIGS. 4 and 5, the solid axle 40 includes, in one embodiment, first and second elongated box channels 47, 48, respectively, which are fabricated from steel, aluminum, composite material etc.

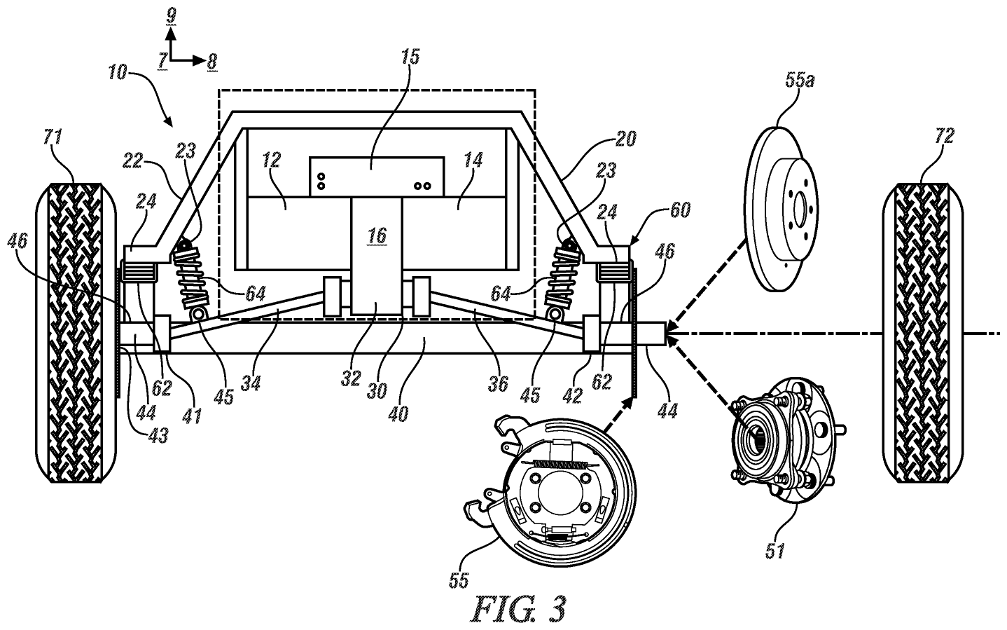

FIG. 6 schematically illustrates a top view of an embodiment of the electrified powertrain system that is described with reference to FIG. 3 that includes an arrangement wherein the first and second hub mounts 43, 44 have a forward-offset arrangement 600 such that the rotational axes of the wheel spindles 51 are offset from the axis of the solid axle 40 along the y-axis. This arrangement may be employed when the solid axle 40 is in a front axle position, or in a forward position on a multi-rear axle vehicle.

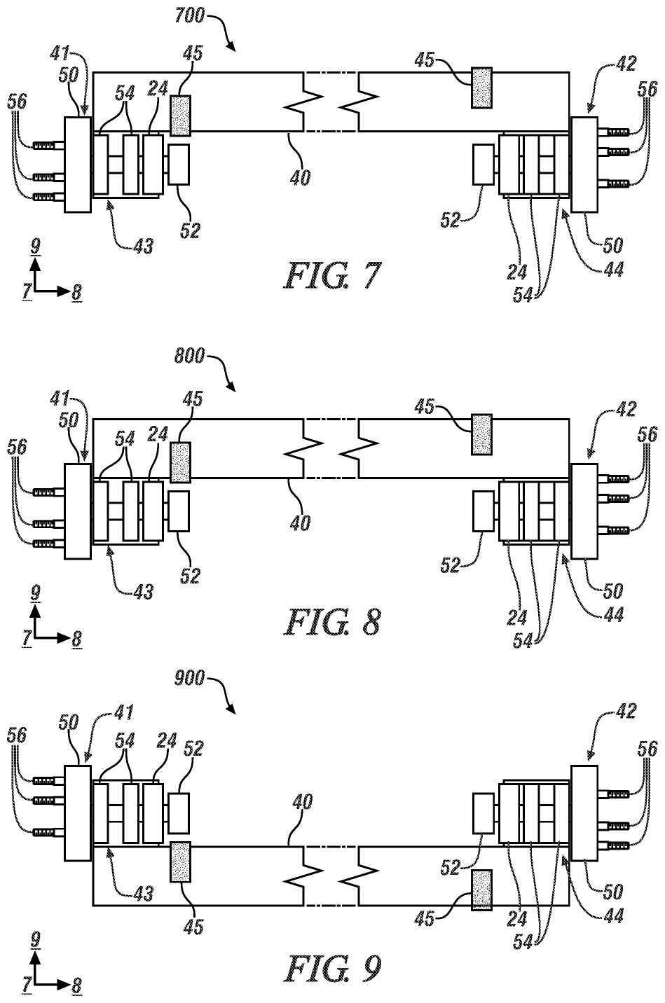

FIG. 7 schematically illustrates a top view of an embodiment of the electrified powertrain system that is described with reference to FIG. 3 that includes an arrangement 700 wherein the first and second hub mounts 43, 44 have a rearward-offset arrangement such that the rotational axes of the wheel spindles 51 are offset from the axis of the solid axle 40 along the y-axis. This arrangement may be employed when the solid axle 40 is in a rear axle position, or in a rearward position on a multi-rear axle vehicle.

FIG. 8 schematically illustrates a rear view of an embodiment of the electrified powertrain system that is described with reference to FIG. 3 that includes an arrangement 800 wherein the first and second hub mounts 43, 44 have a bottom-offset arrangement such that the rotational axes of the wheel spindles 51 are offset from the axis of the solid axle 40 along the z-axis. This arrangement may be employed to increase ground clearance of the vehicle.

FIG. 9 schematically illustrates a rear view of an embodiment of the electrified powertrain system that is described with reference to FIG. 3 that includes an arrangement 900 wherein the first and second hub mounts 43, 44 have a top-offset arrangement such that the rotational axes of the wheel spindles 51 are offset from the axis of the solid axle 40 along the z-axis. This arrangement may be employed to decrease ground clearance of the vehicle.

The following Clauses provide example configurations of an electrified powertrain system for a vehicle.

Clause 1: An electrified powertrain system for a vehicle, including: an electric machine, a gearbox, and first and second half-shafts; and a solid axle, including a first hub mount disposed on a first end thereof, a second hub mount disposed on a second end thereof, and first and second wheel mounts; wherein the first and second wheel mounts are disposed in the first and second hub mounts, respectively; wherein a frame member of the vehicle is supported on the solid axle via springs; wherein the electric machine and the gearbox are rigidly supported on the frame member of the vehicle; and wherein the electric machine is rotatably coupled to the first and second wheel mounts via the gearbox and the first and second half-shafts.

Clause 2. The electrified powertrain system of Clause 1, further including first and second constant velocity joints coupled to the first and second wheel mounts, respectively; wherein the electric machine is rotatably coupled to the first and second wheel mounts via the gearbox, the first and second half-shafts, and the first and second constant velocity joints.

Clause 3. The electrified powertrain system of Clauses 1-2, wherein the frame member includes one of a frame cross-member, a subframe, or a cradle.

Clause 4. The electrified powertrain system of Clauses 1-3, wherein the frame member includes a unibody configuration.

Clause 5. The electrified powertrain system of Clauses 1-4, further including an electric power inverter electrically coupled to the electrical machine.

Clause 6. The electrified powertrain system of Clauses 1-5, wherein the gearbox includes a single input, dual output gearbox.

Clause 7. The electrified powertrain system of Clauses 1-6, further including the frame member of the vehicle being supported on the solid axle via shock absorption devices and the springs.

Clause 8. The electrified powertrain system of Clauses 1-7, wherein the solid axle includes first and second laterally-oriented box channel elements and a stiffening tab that are arranged between first and second hub mounts, wherein the stiffening tab is mechanically coupled to the first and second laterally-oriented box channel elements; and wherein the first and second wheel mounts are attached to the first and second hub mounts via hub bolts.

Clause 9. An electrified powertrain system for a vehicle, including: first and second electric machines, a gearbox, first and second half-shafts, and first and second constant velocity joints; and a solid axle, including a first bearing hub disposed on a first end thereof, a second bearing hub disposed on a second end thereof, and first and second wheel mounts; wherein the first and second wheel mounts are disposed in the first and second bearing hubs, respectively; wherein a frame member of the vehicle is supported on the solid axle via springs; wherein the first and second electric machines and the gearbox are rigidly supported on the frame member of the vehicle; and wherein the electric machine is rotatably coupled to the first and second wheel mounts via the gearbox, the first and second half-shafts, and the first and second constant velocity joints.

Clause 10. The electrified powertrain system of claim 9, further including first and second constant velocity joints coupled to the first and second wheel mounts, respectively; wherein the electric machine is rotatably coupled to the first and second wheel mounts via the gearbox, the first and second half-shafts, and the first and second constant velocity joints.

Clause 11. The electrified powertrain system of Clauses 9-10, wherein the frame member includes one of a frame cross-member, a subframe, or a cradle.

Clause 12. The electrified powertrain system of Clauses 9-11, wherein the frame member includes a unibody configuration.

Clause 13. The electrified powertrain system of Clauses 9-12, further including an inverter electrically coupled to the electrical machine.

Clause 14. The electrified powertrain system of Clauses 9-13, wherein the gearbox includes a dual input-dual output gearbox.

Clause 15. The electrified powertrain system of Clauses 9-14, further including the frame member of the vehicle being supported on the solid axle via shock absorption devices.

Clause 16. The electrified powertrain system of Clauses 9-15, wherein the solid axle includes first and second laterally-oriented box channel elements and a stiffening tab that are arranged between first and second hub mounts, wherein the stiffening tab is mechanically coupled to the first and second laterally-oriented box channel elements; and wherein the first and second bearing hubs are attached to the first and second hub mounts via hub bolts.

Clause 17. A method for configuring a vehicle including an electrified powertrain, the method including: configuring the electrified powertrain to include at least one electric machine, a gearbox, and first and second half-shafts, configuring a solid axle, the solid axle including arranging first and second laterally-oriented box channel elements and a stiffening tab between first and second hub mounts, wherein the first hub mount is disposed on a first end thereof, and the second hub mount is disposed on a second end thereof; attaching first and second wheel mounts to the first and second hub mounts, respectively; arranging the at least one electric machine and the gearbox as a sprung mass, wherein the sprung mass is disposed on a frame member of the vehicle; arranging the solid axle as an unsprung mass; and rotatably coupling the first and second wheel mounts to the first and second half-shafts via constant velocity joints.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. An electrified powertrain system for a vehicle, comprising:
an electric machine, a gearbox, and first and second half-shafts; and
a solid axle, including a first hub mount disposed on a first end thereof, a second hub mount disposed on a second end thereof, and first and second wheel mounts;
wherein the first and second wheel mounts are disposed in the first and second hub mounts, respectively;
wherein a frame member of the vehicle is supported on the solid axle via springs;
wherein the electric machine and the gearbox are rigidly supported on the frame member of the vehicle; and
wherein the electric machine is rotatably coupled to the first and second wheel mounts via the gearbox and the first and second half-shafts.

2. The electrified powertrain system of claim 1, further comprising first and second constant velocity joints coupled to the first and second wheel mounts, respectively; wherein the electric machine is rotatably coupled to the first and second wheel mounts via the gearbox, the first and second half-shafts, and the first and second constant velocity joints.

3. The electrified powertrain system of claim 1, wherein the frame member comprises one of a frame cross-member, a subframe, or a cradle.

4. The electrified powertrain system of claim 1, wherein the frame member comprises a unibody configuration.

5. The electrified powertrain system of claim 1, further comprising an electric power inverter electrically coupled to the electrical machine.

6. The electrified powertrain system of claim 1, wherein the gearbox comprises a single input, dual output gearbox.

7. The electrified powertrain system of claim 1, further comprising the frame member of the vehicle being supported on the solid axle via shock absorption devices and the springs.

8. The electrified powertrain system of claim 1, wherein the solid axle comprises first and second laterally-oriented box channel elements and a stiffening tab that are arranged between first and second hub mounts;
wherein the stiffening tab is mechanically coupled to the first and second laterally-oriented box channel elements; and
wherein the first and second wheel mounts are attached to the first and second hub mounts via hub bolts.

9. An electrified powertrain system for a vehicle, comprising:
first and second electric machines, a gearbox, first and second half-shafts, and first and second constant velocity joints; and
a solid axle, including a first bearing hub disposed on a first end thereof, a second bearing hub disposed on a second end thereof, and first and second wheel mounts;
wherein the first and second wheel mounts are disposed in the first and second bearing hubs, respectively;
wherein a frame member of the vehicle is supported on the solid axle via springs;
wherein the first and second electric machines and the gearbox are rigidly supported on the frame member of the vehicle; and
wherein the electric machine is rotatably coupled to the first and second wheel mounts via the gearbox, the first and second half-shafts, and the first and second constant velocity joints.

10. The electrified powertrain system of claim 9, further comprising first and second constant velocity joints coupled to the first and second wheel mounts, respectively; wherein the electric machine is rotatably coupled to the first and second wheel mounts via the gearbox, the first and second half-shafts, and the first and second constant velocity joints.

11. The electrified powertrain system of claim 9, wherein the frame member comprises one of a frame cross-member, a subframe, or a cradle.

12. The electrified powertrain system of claim 9, wherein the frame member comprises a unibody configuration.

13. The electrified powertrain system of claim 9, further comprising an inverter electrically coupled to the electrical machine.

14. The electrified powertrain system of claim 9, wherein the gearbox comprises a dual input-dual output gearbox.

15. The electrified powertrain system of claim 9, further comprising the frame member of the vehicle being supported on the solid axle via shock absorption devices.

16. The electrified powertrain system of claim 9, wherein the solid axle comprises first and second laterally-oriented box channel elements and a stiffening tab that are arranged between first and second hub mounts;
wherein the stiffening tab is mechanically coupled to the first and second laterally-oriented box channel elements; and
wherein the first and second bearing hubs are attached to the first and second hub mounts via hub bolts.

17. A method for configuring a vehicle including an electrified powertrain, the method comprising:
configuring the electrified powertrain to include at least one electric machine, a gearbox, and first and second half-shafts;
configuring a solid axle, the solid axle including arranging first and second laterally-oriented box channel elements and a stiffening tab between first and second hub mounts, wherein the first hub mount is disposed on a first end thereof, and the second hub mount is disposed on a second end thereof;
attaching first and second wheel mounts to the first and second hub mounts, respectively;
arranging the at least one electric machine and the gearbox as a sprung mass, wherein the sprung mass is disposed on a frame member of the vehicle;
arranging the solid axle as an unsprung mass; and
rotatably coupling the first and second wheel mounts to the first and second half-shafts via constant velocity Joints.
